(19) United States
(12) Patent Application Publication
(10) Pub. No.: US 2026/0356424 A1
(43) Pub. Date: Nov. 12, 2026

(54) Method for Controlling a Vehicle Steering Device, and Vehicle Steering Device of Steer-By-Wire Design

(71) Applicant: Bayerische Motoren Werke Aktiengesellschaft, Muenchen (DE)

(72) Inventor: Matthias SCHOELZEL, Muenchen (DE)

(21) Appl. No.: 19/128,601

(22) PCT Filed: Nov. 7, 2023
(86) PCT No.: PCT/DE2023/100828

§ 371 Date: May 9, 2025

(30) Foreign Application Priority Data
Nov. 10, 2022 (DE) 10 2022 129 691.1

(51) Int. Cl. B62D 6/00; B62D 5/00; B62D 15/02

(52) U.S. Cl. CPC B62D 6/008; B62D 5/006; B62D 15/0215

(57) ABSTRACT

A method for controlling a vehicle steering device designed as a steer-by-wire system is characterized by the following steps: detecting the steering position which a steering handle has when the vehicle is parked, as a starting position; monitoring, in the parked state of the vehicle, by means of a monitoring sensor whether a steering torque acts on the steering handle; and producing a drive torque in the parked state of the vehicle by means of a drive, which drive torque is directed counter to the steering torque. Further, a vehicle steering device with a control unit is provided which is configured to carry out a method of this type.

### BACKGROUND AND SUMMARY

The invention relates to a method for controlling a vehicle steering device designed as a steer-by-wire system. The invention also relates to a vehicle steering device of steer-by-wire design, having a control unit that is configured and programmed to carry out such a method.

Vehicle steering devices of steer-by-wire design are known.

Unlike conventional steering systems, in which the wheels are permanently connected mechanically to the steering handle, and there is an associated steering wheel position for each wheel position, in a steer-by-wire vehicle steering device there is no direct mechanical connection between the wheels and the steering handle. The associated position of the wheels and of the steering handle is effected by servomotors and by means of a correspondingly designed sensor system.

A disadvantage of this steer-by-wire vehicle steering device is that there is a risk that the steering handle can be rotated slightly by persons when the vehicle is parked, and thus an asynchronicity arises between the position of the wheels and the position of the steering handle.

It is therefore the object of the invention to provide a method for controlling a vehicle steering device designed as a steer-by-wire system and a vehicle steering device of steer-by-wire design that ensures synchronicity between the wheels and the steering handle.

The object is achieved by a method for controlling a vehicle steering device designed as a steer-by-wire system, which has a steering handle, a monitoring sensor, and a drive that is configured to apply a drive torque to the steering handle when the vehicle is in a parked state. The method is characterized by the following steps:
a) detecting the steering position that the steering handle has when the vehicle is parked, as a starting position,
b) monitoring, in the parked state of the vehicle, by means of the monitoring sensor whether a steering torque is acting on the steering handle, and
c) producing a drive torque, which is directed counter to the steering torque, in the parked state of the vehicle by means of the drive.

The steering torque is the torque that acts on the steering handle and moves the steering handle out of the starting position into a deflected steering position, for example when a person leans on the steering handle.

Within the meaning of the invention, the vehicle is in a parked state when the vehicle is at a standstill and the prime mover of the vehicle is switched off, for example when the vehicle is parked.

By detecting the steering position that the steering handle has when the vehicle is parked as a starting position, a potential asynchronicity can be compensated for by means of the drive, so that synchronicity between the wheels and the steering handle is ensured when setting off.

Furthermore, by producing a drive torque directed counter to the steering torque in the parked state of the vehicle, comfort is increased, since an otherwise substantially freely rotating steering handle gives no significant impression.

In one embodiment, in step c), a drive torque is produced that fully compensates for the steering torque, so that the steering handle remains in the starting position, and an asynchronicity is reliably prevented. In other words, the steering handle thereby feels rigid without the need for mechanical locking of complex design, which must meet demanding safety criteria.

In this case, the method can also have the step of:
d) reducing the drive torque to a value that is lower than the steering torque after the steering torque has been applied for a certain time period.

In this case, the drive torque can also be reduced to zero, i.e., no drive torque is applied any longer.

By reducing the drive torque after a certain time, the energy consumption is reduced, and thus the vehicle battery that supplies the drive with energy is conserved.

The reduction in the drive torque can take place continuously to increase comfort and give a significant impression.

In a further embodiment, in step c), a drive torque is produced that fully compensates for the steering torque when the steering torque is less than or equal to a maximum value. It is thus ensured that the steering handle remains in the starting position in the case of correspondingly low steering torques.

Additionally or alternatively, in step c), a drive torque can be produced that partially compensates for the steering torque when the steering torque is greater than the maximum value. This means that the steering handle is moved out of the starting position into a deflected position when the steering torque exceeds the maximum value. As a result, the energy consumption is limited, and the drive is effectively protected from damage resulting from an excessively high drive torque.

Furthermore, the method can have the step of:
e) restoring the steering handle to the starting position when no steering torque is effective any longer or when the steering torque is less than or equal to a maximum value, in particular after the steering handle has previously been deflected out of the starting position by a steering torque that exceeded the maximum value.

It can thus be ensured in an energy-efficient manner that the steering handle is oriented in the starting position and thus synchronously with the wheels of the vehicle when setting off.

According to the invention, in order to achieve the aforementioned object, a vehicle steering device of steer-by-wire design is also provided, which has a control unit that is configured and programmed to carry out a method according to the invention, a steering handle, a monitoring sensor, and a drive that is configured to apply a drive torque to the steering handle, and has the aforementioned advantages.

According to one embodiment, the vehicle steering device has, in the parked state of the vehicle, a standby mode, in which the drive and the monitoring sensor are deactivated, and a monitoring mode, in which the drive is ready for operation and the monitoring sensor is active. In this way, the vehicle steering device can be operated in a standby mode in order to reduce energy consumption in comparison with monitoring mode.

In this case, the vehicle steering device can be put into monitoring mode when at least one of the following monitoring events occurs:
a movement in the vehicle interior has been detected by means of a motion sensor,
the vehicle is unlocked,
a driver's door of the vehicle has been opened,
a seat sensor of a driver's seat of the vehicle has been triggered,
a proximity sensor or touch sensor of the steering handle has been triggered.

It can thus be ensured that the vehicle steering device is in monitoring mode when it is possible or probable that a steering torque is applied to the steering handle.

According to a further embodiment, the vehicle steering device is put into standby mode after at least one of the following standby events has occurred:
the vehicle has been locked,
a driver's door of the vehicle has been closed,
no movement has been detected in the vehicle interior by means of a motion sensor for a defined time period,
no change in the state of a seat sensor of a driver's seat of the vehicle has been detected for a defined time period,
no change in the state of a proximity sensor or touch sensor of the steering handle has been detected for a defined time period.

In this way, the vehicle steering device is in energy-efficient standby mode when the risk of a steering torque being applied to the steering handle is low.

Further advantages and features can be found in the following description and in the attached drawings.

### BRIEF DESCRIPTION OF THE DRAWINGS

FIG. 1 is a schematic diagram of a vehicle having a vehicle steering device according to an embodiment of the invention; and

FIG. 2 is a schematic diagram of the vehicle steering device of FIG. 1.

### DETAILED DESCRIPTION OF THE DRAWINGS

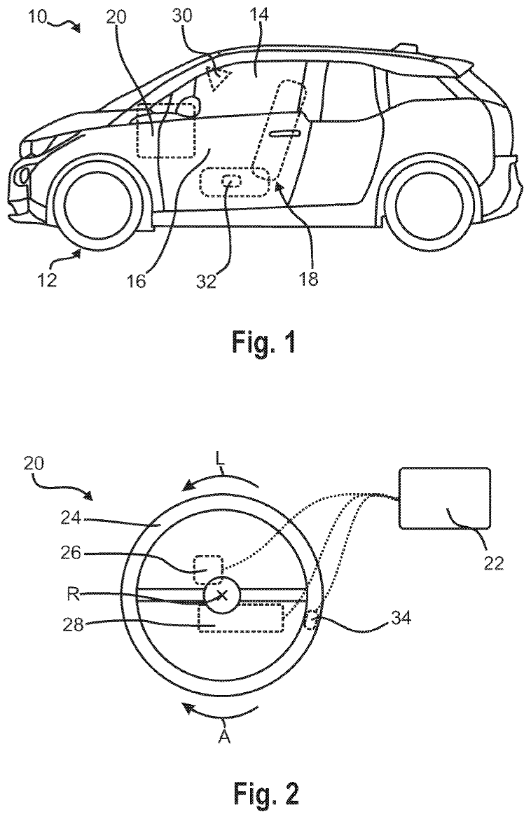

FIG. 1 shows a vehicle 10 having front wheels 12, a vehicle interior 14, a driver's door 16, and a driver's seat 18, which is arranged in the vehicle interior 14 and on which a vehicle occupant can sit down via the driver's door 16.

Furthermore, the vehicle 10 has a vehicle steering device 20, which has a control unit 22 (see FIG. 2) and a steering handle 24, which is arranged opposite the driver's seat 18 and is mounted rotatably about a rotational axis R.

The vehicle steering device 20 is a steer-by-wire system, which is configured to orient the steerable front wheels 12 according to a steering position, i.e., an angle position about the rotational axis R, of the steering handle 24 during operation of the vehicle 10, as a result of which the vehicle 10 can be controlled or steered during driving via the steering handle 24 in a known manner.

In an alternative embodiment, the vehicle steering device 20 can be configured to orient any steerable wheels of the vehicle 10 according to a steering position of the steering handle 24 during operation of the vehicle 10.

To ensure that the steering handle 24 is always oriented synchronously to the front wheels 12 on setting off, the vehicle steering device 20 has a monitoring sensor 26 and a drive 28, which are connected to the control unit 22 for signal transmission.

The drive 28 is an electric motor, in particular a servomotor.

In one embodiment, the drive 28 is part of a force feedback device of the steering handle 24.

In this case, the monitoring sensor 26 is configured to detect the magnitude of a steering torque L acting on the steering handle 24 in the circumferential direction of the rotational axis R.

In one embodiment, for this purpose, the monitoring sensor 26 is coupled to a shaft or a hub of the steering handle 24, by means of which the steering handle 24 is fastened to a vehicle part rotatably about the rotational axis R.

The drive 28 is also configured to drive the steering handle 24 in the circumferential direction of the rotational axis R via a drive torque A.

In one embodiment, for this purpose, the drive 28 can be coupled to a shaft or a hub of the steering handle 24, by means of which the steering handle 24 is fastened to a vehicle part rotatably about the rotational axis R.

The steering torque L and the drive torque A are each illustrated by an arrow in FIG. 2. Of course, the detection of the steering torque L and of the provided drive torque A is not limited to the arrow direction shown but can be detected and provided both in and counter to the arrow direction shown.

In this connection, the vehicle steering device 20 is configured to operate the monitoring sensor 26 and the drive 28 when the vehicle 10 is in the parked state. Therefore, when the vehicle 10 is in the parked state, steering torques L acting on the steering handle 24 can be detected by means of the monitoring sensor 26, and drive torques A acting on the steering handle 24 can be produced by means of the drive 28.

Furthermore, the control unit 22 is configured and programmed to control the vehicle steering device 20 according to the following method.

First, the current steering position of the steering handle 24 is detected and stored as the starting position when the vehicle 10 is parked, i.e., the moment when the vehicle 10 or its prime mover is switched off or immediately beforehand.

The starting position can take place by means of the monitoring sensor 26 or another sensor that is configured to detect the angle position of the steering handle 24.

When the vehicle 10 is in the parked state, the steering handle 24 is then monitored by means of the monitoring sensor 26 in order to determine whether a steering torque L is acting on the steering handle 24.

If such a steering torque L is detected by the monitoring sensor 26, a drive torque A, which counteracts and thus at least partially compensates for the steering torque L, is produced by means of the drive 28.

The drive torque A is at most equal in magnitude to the steering torque L.

In one embodiment, the steering torque L is fully compensated for, in particular over the entire time that the steering torque L lasts.

In an alternative embodiment, the steering torque L is fully compensated for initially. After a certain time for which the steering torque L lasts, the drive torque A is reduced so that the steering torque L is only partially compensated for after this point in time.

The drive torque A can be reduced continuously.

In a further alternative embodiment, immediately after the steering torque L is detected, a drive torque A is produced that is lower than the steering torque L, i.e., the steering torque L is only partially compensated for.

It can depend on the magnitude of the steering torque L whether the steering torque L is fully or only partially compensated for.

For example, in one embodiment, a maximum value is specified, which must not be exceeded by the drive torque A. The steering torque L is thus fully compensated for as long as the steering torque L is less than or equal to the maximum value, while the steering torque L is only partially compensated for when the steering torque L is greater than the maximum value.

Of course, in all cases in which the steering torque L is only partially compensated for, the steering torque L can be fully compensated for in a subsequent phase, in particular in cases in which the steering torque L was above the maximum value and then falls to or below the maximum value.

In cases in which the steering handle 24 has been deflected out of the starting position, for example because the steering torque L was at least temporarily above the maximum value, the steering handle 24 is moved back into the starting position when no steering torque L is effective any longer or when the steering torque L is less than the maximum value.

In cases in which the steering handle 24 is in a position deflected out of the starting position when the vehicle 10 starts, the steering handle 24 can be put into the starting position by means of the drive 28 when the vehicle 10 is ready to operate, in order to synchronize the steering position of the steering handle 24 with the orientation of the front wheels 12.

Additionally or alternatively, the synchronization of the steering position of the steering handle 24 with the orientation of the front wheels 12 can be carried out by a manual actuation of the steering handle 24, for example by the steering movements carried out by a driver immediately after setting off.

Due to the stored starting position, synchronicity between the front wheels 12 and the steering handle 24 can be ensured in this way, at least immediately after setting off.

In an alternative embodiment, a vehicle occupant can be prompted by the vehicle 10 to stop loading the steering handle 24 before starting the vehicle 10 or to stop applying the steering torque L so that the steering handle 24 can be moved into the starting position by means of the drive 28.

To reduce the energy consumption of the vehicle steering device 20, the vehicle steering device 20 has a standby mode, in which the drive 28 and the monitoring sensor 26 are switched off and inactive, respectively, and a monitoring mode, in which the drive 28 and the monitoring sensor 26 are ready for operation and active, respectively.

The vehicle steering device 20 can be configured to be put into monitoring mode when one or more of the following monitoring events occur(s):
a motion sensor 30 of the vehicle 10 detects a movement in the vehicle interior 14,
the vehicle 10 is unlocked,
the driver's door 16 of the vehicle 10 has been opened,
a seat sensor 32 of the driver's seat 18 has been triggered,
a proximity sensor or touch sensor 34 of the steering handle 24 has been triggered.

The vehicle steering device 20 can also be configured to be put into standby mode after one or more of the following standby events has/have occurred:
the vehicle 10 has been locked,
the driver's door 16 has been closed,
no movement has been detected in the vehicle interior 14 by means of the motion sensor 30 for a defined time period,
no change in the state of the seat sensor 32 has been detected for a defined time period,
no change in the state of the proximity sensor or touch sensor 34 has been detected for a defined time period.

In one embodiment, after the at least one standby event has occurred, a defined timer starts to run, and the vehicle steering device 20 is only put into standby mode when the timer has run out. A time buffer is thereby provided after the standby event, in which the vehicle steering device 20 remains in monitoring mode before changing into standby mode in order still to be able to detect an unexpected deflection of the steering handle 24 during this time window.

In this way, a vehicle steering device 20 and a method for the control thereof are provided, which ensure that the steerable front wheels 12 and the steering handle 24 are coupled synchronously.

In particular, a drive torque A that holds the steering handle 24 in the current position or, if excessive manual torques are applied, returns the steering handle 24 to the starting position in a defined manner can be produced by means of the monitoring sensor 26, which is energized in the parked state of the vehicle 10, and the energized drive 28 when the steering handle 24 is rotated.

If a driver is sitting in the parked vehicle 10 and produces a steering torque L on the steering handle 24 by leaning on it, a drive torque A that counteracts the steering torque L can initially be produced by the drive 28 and then reduced gradually after a certain time in order to conserve the vehicle battery, with the result that the steering handle 24 rotates. If the driver does not lean thereon, the steering handle 24 is rotated back into the starting position by means of the drive 28.

The invention is not limited to the embodiment shown. In particular, individual features of one embodiment can be combined as desired with features of other embodiments, in particular independently of the other features of the corresponding embodiments.

1.-10. (canceled)

11. A method for controlling a vehicle steering device configured as a steer-by-wire system and having a steering handle, a monitoring sensor, and a drive that is configured to apply a drive torque to the steering handle when the vehicle is in a parked state, the method comprising the steps of:
a) detecting a steering position of the steering handle when the vehicle is parked into a parked state, as a starting position;
b) monitoring, in the parked state of the vehicle, via the monitoring sensor, whether a steering torque is acting on the steering handle; and
c) producing a drive torque which is directed counter to the steering torque in the parked state of the vehicle via the drive.

12. The method according to claim 11, wherein, in step c), the drive torque produced fully compensates for the steering torque.

13. The method according to claim 12, further comprising the step of:
d) reducing the drive torque to a value that is lower than the steering torque after the steering torque has been applied for a certain time period.

14. The method according to claim 13, wherein the reduction in the drive torque takes place continuously.

15. The method according to claim 11, wherein,
in step c), the drive torque produced fully compensates for the steering torque when the steering torque is less than or equal to a maximum value and/or partially compensates for the steering torque when the steering torque is greater than the maximum value.

16. The method according to claim 11, further comprising the step of:
restoring the steering handle to the starting position when no steering torque is effective any longer or when the steering torque is less than or equal to a maximum value.

17. The method according to claim 16, wherein
the restoring of the steering handle to the starting position when no steering torque is effective any longer or when the steering torque is less than or equal to a maximum value occurs after the steering handle has previously been deflected out of the starting position by a steering torque that exceeded the maximum value.

18. A vehicle steering device, comprising:
a steer-by-wire steering system;
a steering handle;
a monitoring sensor;
a drive that is configured to apply a drive torque to the steering handle, and
a control unit operatively configured to:
a) detect a steering position of the steering handle when the vehicle is parked into a parked state, as a starting position;
b) monitor, in the parked state of the vehicle, via the monitoring sensor, whether a steering torque is acting on the steering handle; and
c) produce a drive torque which is directed counter to the steering torque in the parked state of the vehicle via the drive.

19. The vehicle steering device according to claim 18, wherein
the vehicle steering device has, in the parked state of the vehicle, a standby mode, in which the drive and the monitoring sensor are deactivated, and a monitoring mode, in which the drive is ready for operation and the monitoring sensor is active.

20. The vehicle steering device according to claim 19, wherein the vehicle steering device is put into monitoring mode when at least one of the following monitoring events occurs:
a movement in a vehicle interior has been detected via a motion sensor,
an unlocking of the vehicle,
a driver's door of the vehicle has been opened,
a seat sensor of a driver's seat of the vehicle has been triggered, or
a proximity sensor or touch sensor of the steering handle has been triggered.

21. The vehicle steering device according to claim 20, wherein the vehicle steering device is put into standby mode after at least one of the following standby events has occurred:
a locking of the vehicle,
the driver's door of the vehicle has been closed,
no movement has been detected in the vehicle interior via the motion sensor for a defined time period,
no change in the state of the seat sensor of a driver's seat of the vehicle has been detected for a defined time period, or
no change in the state of a proximity sensor or touch sensor of the steering handle has been detected for a defined time period.

22. The vehicle steering device according to claim 17, wherein the vehicle steering device is put into standby mode after at least one of the following standby events has occurred:
a locking of the vehicle,
the driver's door of the vehicle has been closed,
no movement has been detected in the vehicle interior via the motion sensor for a defined time period,
no change in the state of the seat sensor of a driver's seat of the vehicle has been detected for a defined time period,
no change in the state of a proximity sensor or touch sensor of the steering handle has been detected for a defined time period.
